(19) United States
(12) Patent Application Publication
(10) Pub. No.: US 2018/0109138 A1
(43) Pub. Date: Apr. 19, 2018

(54) Dual Active Signal Path Power Transmission and Reception

(71) Applicant: Chithra Kirthi Gamini Piyadasa, Kandana (LK)

(72) Inventor: Chithra Kirthi Gamini Piyadasa, Kandana (LK)

(21) Appl. No.: 15/709,648

(22) Filed: Sep. 20, 2017

(30) Foreign Application Priority Data
Oct. 9, 2016 (IB) PCT/IB2016/056041

(51) Int. Cl. H02J 50/10; H02J 50/20

(52) U.S. Cl. CPC H02J 50/10; H04B 5/0037; H02J 50/20

(57) ABSTRACT

An efficient method and device for power transmission is provided by using a transmitting system having two active signal path that are generated by a ground-less complimentary oscillator, which uses complementary configuration using complementary semiconductor devices/pair and amplified by single or cascaded ground-less complimentary amplifiers, which uses complementary configuration using complementary semiconductor devices/pair, directly connected to a symmetric antenna system. At the reception, signals are detected by a symmetric antenna and amplified by a similar single or cascaded ground-less complimentary amplifiers.

This invention relates to an efficient method and device for power/energy transmission. The method and device achieve a significant advantage over the conventional power transmission and reception systems. The transmission can occur through any medium including free space and electrically conductive materials. The transmission can carry encoded data/information or can be a simple electrical power with or without data.

### BACKGROUND OF THE INVENTION

Propagation of energy in space is described in two main models, named as wave theory and quantum theory. However, the concept of energy and its propagation are being debated with respect to its nature of modality of transmission causing many an argument (wave-particle duality). However, almost all the inventions and designs in RF field and the understanding of problems associated with transmitting, propagation and receiving systems have being done with the application of the concept of wave theory. In the conventional concept of the electromagnetic wave, the wave consists of self-propagating transverse oscillating coupled waves of electric and magnetic fields perpendicular to each other and perpendicular to the direction of propagation of energy.

Wireless Radio transmitter (WRT) is an electronic device aided with an antenna which is used to produce and radiate radio frequency (RF) energy into space. In the case of radio frequency range, Wireless Energy (WE) emitted from the antenna propagates throughout the space. Antennae are designed in order to radiate this wireless energy into desired area and can radiate isotropically or directionally. WE is in the radio frequency (RF) spectrum range from 3 KHz (extremely low frequency) to 3000 GHz (Tremendously high frequency) and travels with a speed of light (3×108 meter/second) throughout the space. This is used to carry information from point to point. WE is embedded with information, such as voice, video, data etc, by means of various type of modulation techniques. Amplitude modulation (AM), frequency modulation (FM), phase modulation (PM) are some of the techniques used to embed information into the WE, usually called carrier frequency. Power radiated in the form of RF signal is then captured by a receiver antenna and filter out the information embedded in it. In a RF system, it is very important to radiate sufficient power into desired area with the minimum transmitter power and interference. In addition to that, the RF power radiated from the antenna undergo various optical phenomena, such as reflections, refraction, diffraction, interference, absorption etc. and these directly affects the quality of the signal at the receiving end.

The technical solution proposed here is an invention based on the novel theory of spin Momentum Energy Field (MEF) proposed by the inventor to describe the inner working of the invention. The novel theory proposes that the energy exists in the foam of spin momentum energy which is associated with a spin either in matter (as spin energy) or in field (or as spin energy field). When energy propagates, it consists of two identical components of MEF with opposing directions of spin, propagated successively. This field has the ability to impart energy in the form of spin momentum to any particle that they encounter it in space. MEF can transmit through any medium including free space and matter. The MEFs traveling in the same space (conductor) in opposite directions with opposite spins, is defined as electric current.

The technical solutions for power transmission is achieved by utilizing the said concept of two identical momentum energy fields with opposing direction of spin. Signal generator produces these two MEF signals with opposing direction of spin and then amplify utilizing two separate signal paths. This invention utilizes MEF concept in the designing of frequency generator (oscillator), an amplifier/power transmitter, receiver and antenna without a ground plane. This improves both the power and quality of signals received due to the absence of a ground plane in the system. The design maintains two separate channels to amplify the two components of the MEF. This improves the power output thus extending receivable distance and the reduction of interference in space.

It is believed that a clear understanding of the way in which energy is generated and subsequently transmitted through free space would help to discover novel properties and aspects of the behaviour of energy (electromagnetic energy in classical theory) leading to novel and more effective design of many appliances, including but not limited to propagation of energy, energy harvesting, energy storage, and all allied equipment developed and available presently in practice which based and developed on classical electromagnetic theory.

The underlying basis of the invention is the understanding of the nature of the energy and its propagation. The transferring nature of electrical energy to its dynamic mode in space for propagation is effectively utilised in this invention. To achieve the improved performance as described, two energy flowing paths are defined. Conventional ground reference and the signal association with ground potential in the circuitry is eliminated in the invention.

### SUMMARY OF THE INVENTION

According to the invention there is provided a method of generating and transmitting electromagnetic power/energy comprising:

at signal generator stage, generating a signal using a ground-less complimentary oscillator which uses complementary configuration using complementary semiconductor pair/devices so that the signal is generated between two active terminals reference to each other;

wherein the oscillator operates without a common/fixed/ground potential;

amplifying the signal using at least one ground-less dual-feed complementary amplifier stage which uses complementary configuration using complementary semiconductor pair/devices so that the signal amplifies through two active paths with reference to each other;

wherein the amplifier operates without common/fixed/ground potential;

transmitting the amplified signals through a medium to a receiving stage;

and at the receiving stage, amplifying the received signal through a cascade of ground-less dual-feed complementary amplifier stages where the complimentary amplifying stage amplifiers of the receiving stage operate without common/fixed/ground potential so that the signals are independently flowing in two active paths relative to each other.

Most of the current carried by electrons is generally called N-type semiconductors and most of the current carried by holes is generally called P-type semiconductors. A pair of corresponding N-type and P-type active semiconductor devices with near identical characteristics to each other are called Complementary semiconductor pair/devices.

An oscillator generates signals at two output terminals with reference to each other by using active semiconductor device which contain complimentary semiconductor pair. No ground, fixed or common potential is defined relative to the derived signal in the circuitry and the signal is generating between two terminals relative to each other. Hereafter, this oscillator is named as ground-less complementary oscillator.

A signal generated by the ground-less complementary oscillator can be amplified by using active semiconductor device which contains complimentary semiconductor pair. As in the ground-less complementary oscillator, there is no ground, fixed or common potential is defined in the circuitry and the signal is flowing between two active signal paths relative to each other. The device that amplify signal generated by the ground-less complementary oscillator is named as a ground-less dual-feed complementary amplifier.

The signal coupling from the ground-less complementary oscillator to the ground-less dual-feed complementary amplifier or between the ground-less dual-feed complementary amplifiers is achieved by two conducting wires wound certain number of turns on a ferrite core in bifilar configuration. Hereafter, this signal coupling transformer is named as symmetrically fed balance-to-balance transformer.

Any number of the ground-less dual-feed complementary amplifiers can be cascaded, to obtain desired signal level/power,

The amplified signal by the ground-less dual-feed complementary amplifier is then directly connected to the symmetric radiators (with appropriate dimensions of the wavelength, of radiating frequency) such as dipole or loop antennas without having rather complicated frequency tuning, impedance matching and filtering circuitry.

At the receiving stage, the received signal induced in symmetric antennae is amplified through single or a cascade of the ground-less dual-feed complementary amplifiers using symmetrically fed balance-to-balance transformer.

The ground-less dual-feed complementary amplifiers of the receiving stage are also amplified signal having no ground, fixed or common potential.

In the present invention, the signal generated by ground-less complementary oscillator, and amplified at the transmitter and receiver by ground-less dual-feed complementary amplifier stages which do not use any reference such as ground or common potential. At the transmission and reception, signal is directly coupled to the symmetric dipole or loop antenna.

The present invention is applicable for free space power (RF and electrical) transmission and reception systems as well where the signal is transmitted through electrical conductors.

The key feature of this invention, the oscillator and the amplifier, is the signal generate and amplify respectively without a ground, fixed or common reference but the signal exists between two active terminals reference to each other. Therefore, there is no common/fixed/ground potential in the arrangement herein which is defined as ground-less. The property of “ground-less” is achieved by using complimentary configuration or electronic circuit. For the complementary configuration, the method uses complementary electronic components. The signal is sharing two active signal paths in complementary configuration. A complementary configuration, where signal is flowing between only two active signal paths, to generate and amplify signals is new. Those signals flow relative to each other and no ground/fixed/common is existed in the new invention.

In the prior art, conventional configuration, signal is always defined and flowed relative the ground. The ground plane is distributed in the circuitry and is also acted as a radiating element with an equal probability. This is the main drawback, restricting efficient transmission signal from the conventional transmitters. The present invention identifies the nature of the energy and its propagation, and use it to eliminate the drawback due to the presence of the ground in present transmitting and receiving circuitry. This modification gives equal probability to the signal which is flowting between two active signal path all the way through from generation to the transmission. In conventional circuitry, the signal is always generated and amplified up to the final stage of the transmitter relative to the ground potential which also acts as an indirect radiator. The ground plane is distributed all over the circuitry and therefore no perfect radiation occurs. It is also matching mechanisms are needed to transfer power between stages as well as the final power amplifier to the antenna.

This invention is about a novel and improved method and device for transmission and reception of energy which is described using novel model justifying the internal workings of the said transmitter and the receiver. This invention has been proven experimentally.

For example, the following output performance have been found. For a given output of the transmitting device in the conventional transmitter and the transmitter of the invention, the measured voltage induced at the receiving end of the new invention is higher than the induced voltage at the receiving end of the conventional system. For a given output of the transmitting device in the conventional transmitter and the transmitter of the invention, the power consumed by the new invention is lower than the power consumed by the conventional system. Further, the invention achieves better signal to noise ratio as the antenna which is used in conjunction with said complementary amplifiers acts as a theoretically described perfect radiator thereby increasing the quality of transmission and reception.

Using two active signal paths for the signal, improves both the power and quality of signals received due to the absence of a ground plane. The design maintains two separate channels to amplify the signal. This improves the power output thus extending receivable distance and the reduction of interference in space.

Examples of the use of this system include but not limited to, Point to Point communication, Communication to and from space satellites, Conventional transmission, cable and wireless transmission of power, transmission of any part of the Electromagnetic spectrum.

### BRIEF DESCRIPTION OF THE DRAWINGS

One embodiment of the invention will now be described in conjunction with the accompanying drawings in which:

FIGS. 1A and 1B illustrate graphically the mechanism of Momentum Energy Field, that is how energy field is created and how they initiate propagation at the origin. It also explains how it interact with matter and continue to propagate as it emanating from the original source

FIG. 2 is a block diagram of a conventional PRIOR ART radio frequency transmitter.

FIG. 3 is an electronic circuit configuration of a conventional PRIOR ART radio frequency transmitter.

FIG. 4 is a block diagram of a conventional PRIOR ART radio frequency transmitter which uses differential amplifiers.

FIG. 5 is an electronic circuit configuration of a conventional PRIOR ART radio frequency transmitter which uses differential amplifier.

FIG. 6 is a block diagram of radio frequency receiver according to the conventional system.

FIG. 7 is an electronic circuit configuration of a radio frequency ground-less complementary oscillator or signal generator according to the present invention.

FIG. 8 is a first alternative of an electronic circuit configuration of a radio frequency ground-less dual-feed complementary amplifier according to the present invention.

FIG. 9 is a second alternative of an electronic circuit configuration of a radio frequency ground-less dual-feed complementary amplifier according to the present invention.

FIG. 10 is a block diagram of a further embodiment of for complete transmitter according to the present invention which uses cascaded complementary configuration for power transmission.

FIGS. 11A and 11B show a schematic illustration of a symmetrically fed balance-to-balance transformer according to the present invention.

FIG. 12 is a block diagram of radio frequency receiver according to the present invention

FIG. 13 is an illustration showing a demonstration of effective electrical power transfer with newly developed amplifier.

FIG. 14 block diagram of a further embodiment for complete transmitter explaining under the concept of momentum energy field.

### DETAILED DESCRIPTION

In a convention system shown for example in US Published application 2005/0075083 of Cairo published Apr. 7, 2005 or in US Published application 2003/0092408 of Frank published May 15, 2003 or Wikipedia as shown in FIGS. 2, 3, 4, 5 and 6 herein, there is only one/two (either one or two) signal flowing relative to the ground. In the above patent documents, both use differential signals but still they are defined relative to the ground.

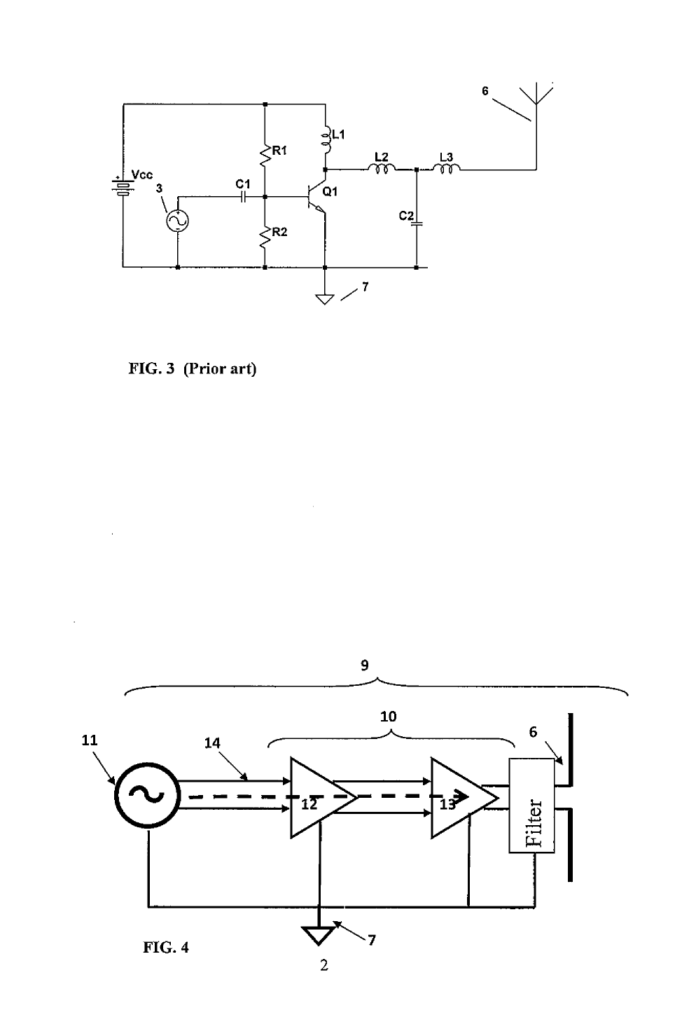

The conventional transmitters 1 act as the transmitters according to the existing methodology, see FIG. 2 and FIG. 3, contains three main stages, oscillator 3, amplifier 2 which may contain series of pre-amplifiers 4 and power amplifiers 5 and the antenna 6. The signal is always generated and fed into respective stages relative to the ground 7 as shown in FIGS. 2 and 3. The ground 7 is considered at a constant or zero potential, that is virtually no signal flows because it is in zero potential, and the signal which is the change in potential, flows through amplifiers as indicated at dashed lines 8 in FIG. 2. The receiver FIG. 6 consists of antenna 19, pre 20 and post 21 amplification and the load 22 which receives the amplified signal with embedded information in the signal. Similarly, the signal 23 is induced in the antenna and amplified and detected relative to the ground potential 7 of the receiver system.

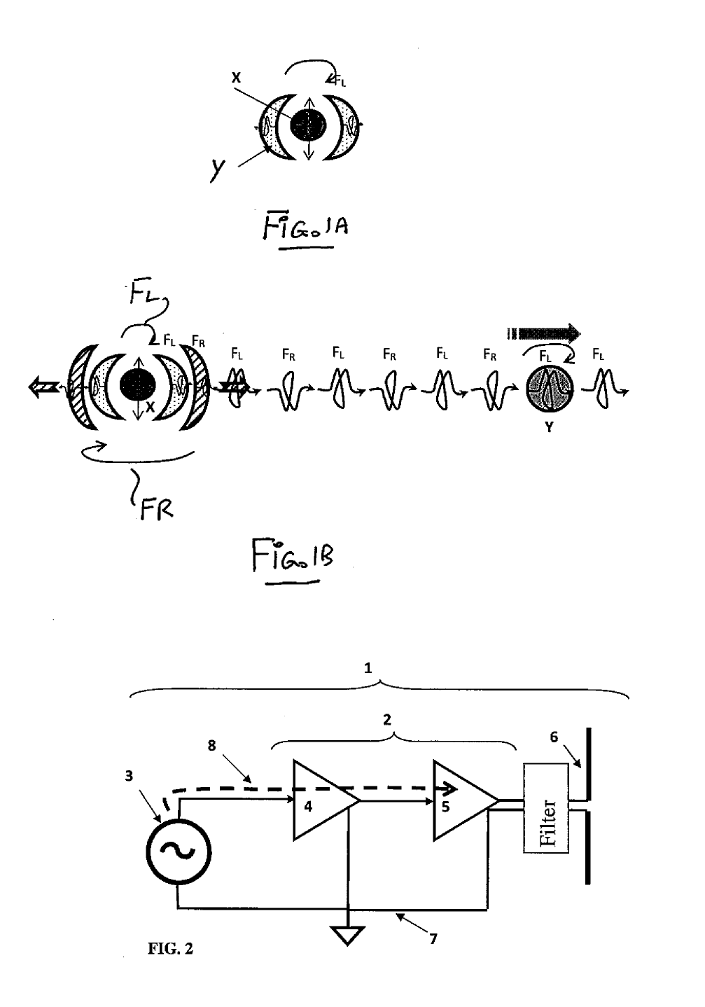

FIGS. 1A and 1B show the Mechanism of Momentum Energy Field Y, that is how energy fields created and how they initiate propagation at the origin. a) Energy of each and every particle is represented by its spin. When particle spins, it creates a field around it. For a constant spin, this would be a static spin-energy field. This field uniquely replicates energy of the particle. This field acts as an integrated form of spin-energy in the particle. An energy field can exist with or without the association of a particle. b) Spin of particle in opposite directions produces left-handed F_{L} and right-handed F_{R} energy fields. It is defined that the energy with same spin direction attracting each other and energy with opposite spin direction repulsing each other. The travelling energy starts due to repulsiveness of the consecutive energy fields at the origin X. F_{R} pushes outward by lately produced energy field F_{L}. This repulsion initiates the dynamic nature of the energy propagation. FIG. 1B shows that the particle X continuously generates series of the left-handed and the right-handed momentum energy fields by oscillation. The energy fields consist of two components, F_{L} and F_{R} propagates successively in free space. These two successive fields are identical in all aspects except for the direction of spin. The particle Y absorbs energy (F_{L}—Field with left-handed spin) from incoming MEF and spins to respective direction. The direction of the spin of the particle is the spin of momentum of the received energy field F_{L}. When particle spins, it also produces its own MEF, F_{L} (Field with left-handed spin and also re-transmitter from the particle Y) and radiates outwards. However, the next proceeding energy field is F_{R} to the particle Y, therefore the produced F_{L} energy field from the particle are emitted towards forward direction because there is repulsiveness with succeeding EMF coming behind F_{R}. The particle is relaying energy by receiving and re-transmitting MEF to the direction of propagation.

Referring now to FIG. 2 there is shown a block diagram of a conventional radio frequency transmitter 1. Transmitter 1 consists of Oscillator 3, Amplifier 2 (pre 4 and post 5), Filter and the radiator (Antenna) 6. Radio frequency signal is generated at oscillator 3 and flowing via the path 8 pre 4 and post 5 amplifiers and filter network to the antenna 6 relative to the ground reference 7 which is at fixed potential.

Referring now to FIG. 3 there is shown electronic circuit configuration of a conventional radio frequency transmitter. Radio frequency signal generates at the oscillator 3 and amplified by the transistor amplifier Q1 relative to the ground potential 7. Vcc is the power source. R1, R2 provided suitable bias voltage for the transistor Q1. Inductance L1 acts as a RF chock. Radio frequency signal is fed to the transistor via capacitor C1. L2, L3, and C2 provided suitable matching and filter network between transistor amplifier Q1 and the antenna 6.

Referring now to FIG. 4 there is shown a block diagram of a conventional radio frequency transmitter which uses differential amplifier configuration. transmitter 9 consists of Oscillator 11, Amplifier 10 (pre 12 and post 13) and the Radiator (Antenna) 6. Radio frequency signal is generated at oscillator 11 and flowing via the path 14 pre 12 and post 13 amplifiers to the antenna 6 via a filter network relative to the ground reference 7 which is at fixed potential.

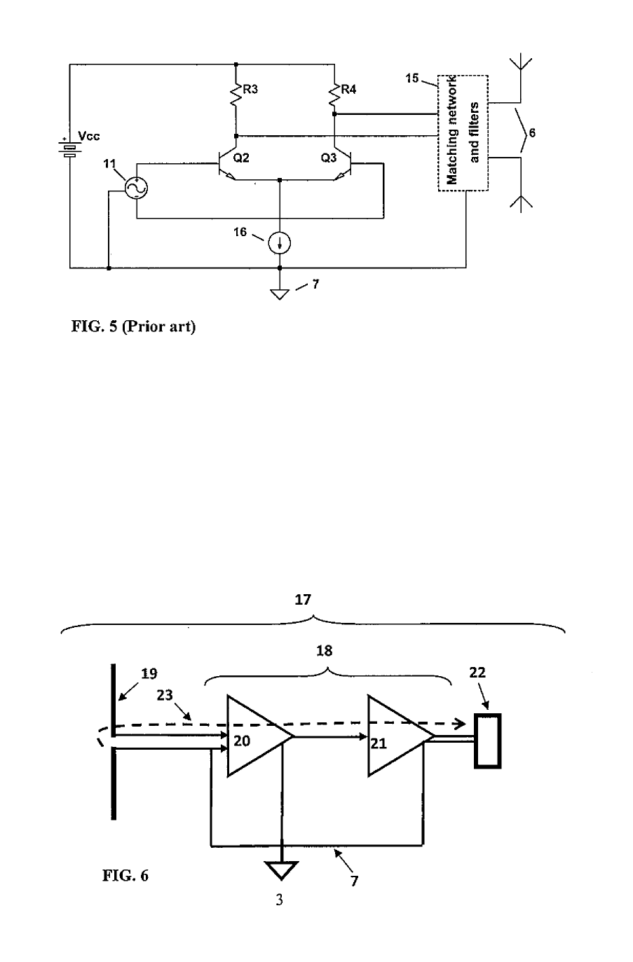

Referring now to FIG. 5 there is shown an electronic circuit configuration of a conventional radio frequency transmitter which uses differential amplifier. Vcc is the power source. Signal generate at the oscillator 11 and amplified by the fully differential amplifier. The differential amplifier consists of transistors Q2, Q3 and two resistors R3 and R4. Signal from oscillator is fed to the bases (differential inputs) of the two transistors Q2 and Q3. Emitters of the transistor Q3 and Q4 are connected together and connected to the ground 7 via a current source 16. Amplified signals at collectors of two transistors Q3 and Q4 are fed to the antenna 6 via a suitable matching and filter network. The radio frequency signal generated at the oscillator is fed to the bases of transistors Q3 and Q4 relative to the ground potential 7. However, the signal from the oscillator up to the output of the final amplifier, just before feeding to the antenna flow relative to the ground potential 7 or one terminal of the power supply Vcc.

Referring now to FIG. 6 there is shown a block diagram of a conventional radio frequency receiver 17. Receiver 17 consists of antenna 19, Amplifier 18 (pre 20 and post 21), and the load 22 6. Radio frequency signal is detected at antenna 19 and flowing via the path 23 through pre 4 and post 5 amplifiers to the load 22 relative to the ground reference 7 which is at fixed potential.

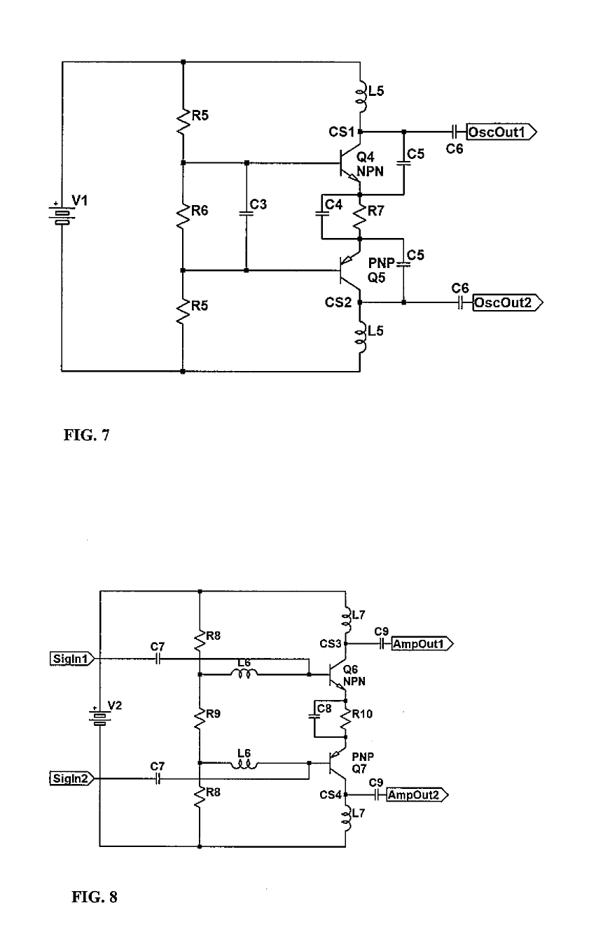

Referring now to FIG. 7 there is shown a circuit diagram of the ground-less complimentary symmetric oscillator. The oscillator uses complementary semiconductors NPN Q4 and PNP Q5 transistors to generate the signal between OscOut1 and OscOut2. However, Q4 and Q5 can be any active components with complementary electrical properties. The two Resistors R5 and Resistor R6 provide biasing voltages and enable oscillation with complimentary semiconductor devices Q4 and Q5. Capacitors C3, C4, C5 and resistor R7 determine the oscillator frequency. Two capacitors C5 also provides feedback to sustain the stable oscillation for the complementary symmetric oscillator. Inductors L5 are radio frequency chocks for providing currents to operate complementary semiconductor devices Q4 and Q5 and block the signal to be leaked out from its active path. The oscillating signal is fetched between two active outputs of complementary semiconductor devices, collectors CS1, CS2 of two complementary transistors, and available between OscOut1 and OscOut2 via capacitors C6. The oscillating signal is available between terminals OscOut1 and OscOut2 with reference to each other. The signals at the active outputs CS1, CS2 flow relative to each other and no ground/fixed/common voltage point is provided or exists. Voltage source V1 provides the electrical power to operate the complimentary symmetric oscillator.

Referring now to FIG. 8 there is shown an electronic circuit configuration of a ground-less dual-feed complementary amplifier to achieve two active signal paths for a signal which flows without no ground/fixed or common reference. Signal is fed between SigIn1, SigIn2 and through capacitors C7, to the complementary semiconductors devices NPN Q6, PNP Q7, forming a ground-less dual-feed complementary amplifier. The two Resistors R8 and Resistor R9 provide suitable bias voltages for the complementary semiconductors devices NPN Q6, PNP Q7. Transistors Q6, Q7 amplify the signals which flow relative to each other without reference to any ground/fixed or common voltage point. Q6 and Q7 can be any active components with complementary electrical properties. Radio frequency chocks L6, L7 provide necessary currents to operate complementary semiconductor devices Q6 and Q7 and block the signal to be leaked out from its active path. The resistor R10 and the capacitor C8 provide the stability for the operation in ground-less dual-feed complementary amplifier. The signal at the active output CS3, CS4 flows relative to each other and no ground/fixed/common voltage point is existed for it. The output signal is existed between terminals SigOut1 and SigOut2 through capacitors C9 with reference to each other. Voltage source V2 provides the electrical power to operate the ground-less dual-feed complementary amplifier.

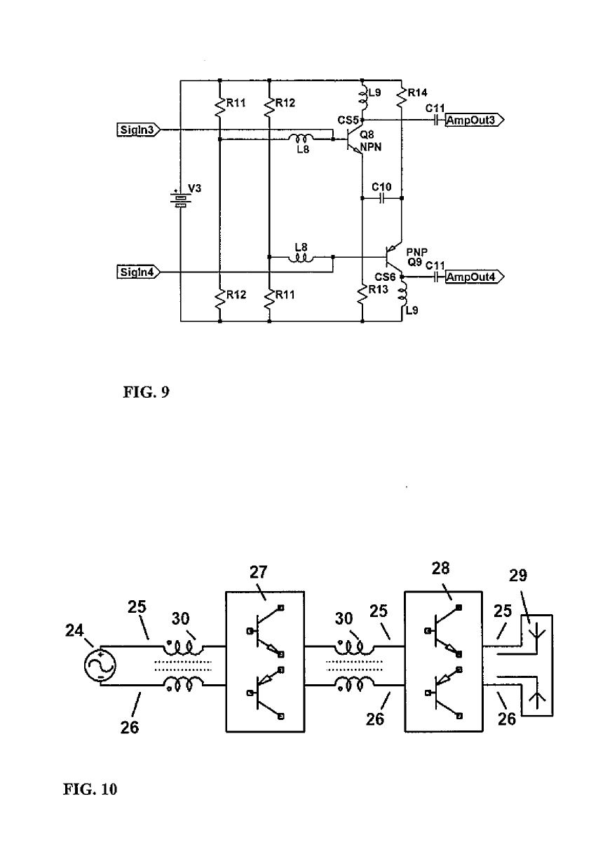

Referring now to FIG. 9 there is shown a second alternative of an electronic circuit configuration for a radio frequency ground-less dual-feed complementary amplifier according to the present invention. The signal is fed between SigIn3, SigIn4 to the complementary semiconductors devices NPN Q8, PNP Q7, forming a ground-less dual-feed complementary amplifier. The combination of Resistors R11, R12 provides suitable bias voltages for the complementary semiconductors devices NPN Q8, PNP Q9. Transistors Q8, Q9 amplify signal which flows relative to each other without reference to any ground/fixed or common voltage point. However, as described in FIGS. 7, Q8 and Q9 can be any active components with complementary electrical properties. The signal fed by the SigIn3 and SigIn4 is amplified by the complementary semiconductors devices NPN Q8, PNP Q9. Signal is coupled between Q8 and Q9 by the capacitor C10. Radio frequency chocks L8 and L9 provide currents to operate complementary semiconductor devices Q8 and Q9 and block the signal to be leaked out from its active path. The signal at the active output CS5, CS6 flows relative to each other and no ground/fixed/common voltage point is existed for it. The output signal is defined between terminals SigOut3 and SigOut4 through capacitors C11 with reference to each other and not to a ground voltage. Voltage source V3 provides the electrical power to operate the ground-less dual-feed complementary amplifier.

Referring now to FIG. 10 there is shown a block diagram of the dual active paths transmitter which uses ground-less complementary configurations. The signal generated in ground-less complementary oscillator 24 flows in two active paths 25, 26. Two active paths 25, 26 are provided by pre 27 and post 28 ground-less dual-feed complementary amplifiers. The signals at complementary output of ground-less dual-feed complementary amplifiers 28 are directly connected to the symmetric radiator 29. The radiator can be either symmetric dipoles or symmetric loop antenna. Oscillator/amplifiers and amplifier/amplifier are cascaded using symmetrically fed balance-to-balance transformer 30.

Referring now to FIGS. 11A and 11B there is shown a symmetrically fed balance-to-balance transformer electrical configuration (a) and physical view (b). Two equal windings AB 31, A′B′ 32 of 10 turns wound in the same direction (bi-filer winding) on ferrite core 33 are used to transfer signal between complimentary amplifiers.

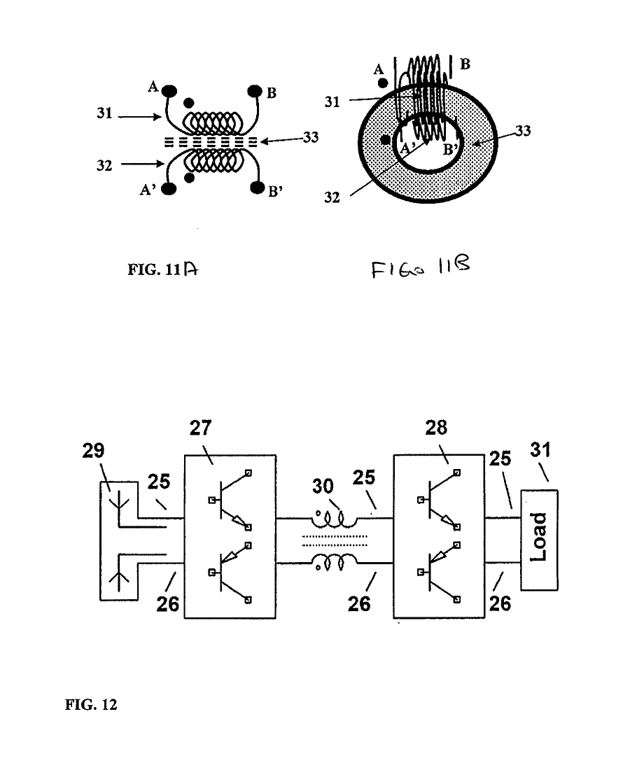

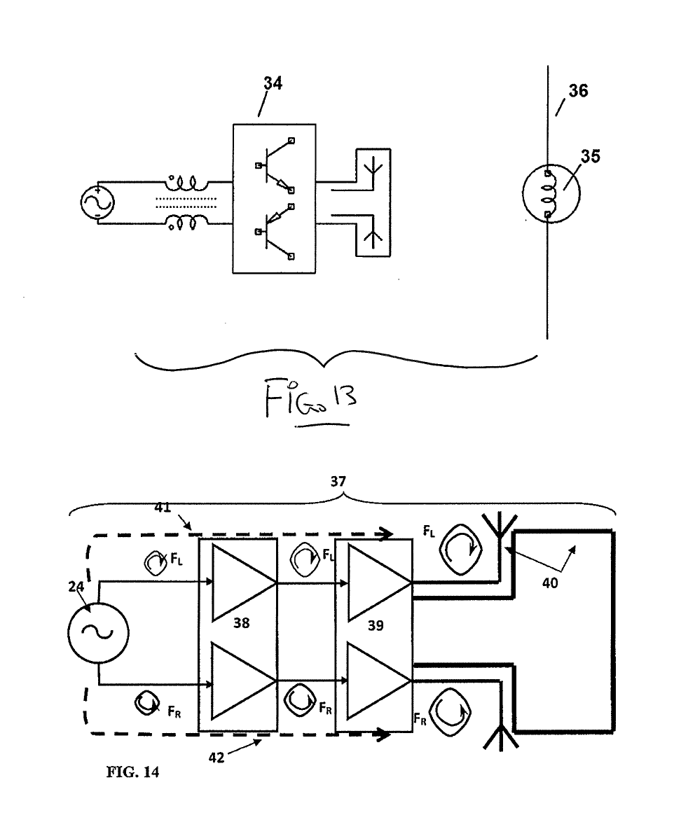

Referring now to FIG. 12 there is shown a block diagram of the dual active paths receiver which uses ground-less complementary configurations. The signal is induced in either symmetric dipoles or symmetric loop antenna 29 flows in two active paths 25, 26 similar to the transmitter in FIG. 9. Two active paths 25, 26 are provided by pre 27 and post 28 ground-less dual-feed complementary amplifiers. The signal at complementary output of ground-less dual-feed complementary amplifier 28 is directly connected to the Load 31. The ground-less dual-feed complementary amplifiers are connected using symmetrically fed balance-to-balance transformer 30.

Referring now to FIG. 13 there is shown a novel ground-less complementary transmitter 34 which can efficiently radiate electrical power to light up an incandescent lamp 35 which is directly coupled to a symmetric antenna 36 at a distance point.

Referring now to FIG. 14 there is shown an Instantaneous view of the distribution of MEF in the ground-less complimentary transmitter 37. The ground-less complementary oscillator 24 produces series of MEFs FL and FR successively as depicted in FIGS. 1A and 1B. Because FL and FR are repulsive each other, they exist in two different paths 41, 42. Cascaded ground-less dual-feed complementary amplifiers 38, 39 amplify signal in two paths which has no reference point such as ground, fixed or common potential and guide two opposite MEFs FL and FR till the radiators 40. Two symmetric radiators can be used such as either dipole or loop antenna 40. Left handed (FL) and right handed (FR) spins will be alternatively radiated in to free space from the antenna 40.

As shown in FIG. 7, at a signal generator stage a signal using a complimentary oscillator which uses complementary semiconductor devices/pair. The oscillator generates signal at two output terminals OscOut1 and OscOut2 with reference to each other. No ground, fixed or common potential is defined or included in the circuitry and the signal is flowing between two active signal paths.

The signal flowing in two active paths relative to each other is amplified using at least one ground-less complimentary amplifying stage.

No ground, fixed or common potential is defined or included as in conventional amplification in the circuitry and the signal is flowing between two active signal path.

The signals flowing between stages oscillator to amplifier or between amplifiers are achieved via symmetrically fed balance-to-balance transformer.

The final signal is then directly connected to the symmetric radiators, with appropriate dimensions of the wavelength, of radiating frequency such as dipole or loop antennas without having rather complicated frequency tuning, impedance matching and filtering circuitry. When the signal is transmitted through free space.

The amplified signals are transmitted through a medium to a receiving stage.

At the receiving stage shown in FIG. 10, the received signal induced in symmetric antennae are amplified through a cascade of ground-less dual-feed complementary amplifiers.

The ground-less dual-feed complementary amplifier of the receiving stage generate also an amplified signal having no ground, fixed or common potential as in conventional systems.

In the present invention, the signal-is generated, amplified, transmitted and received by ground-less complimentary oscillator and amplified by ground-less complimentary amplifier stages which do not use any reference such as ground or common potential in conventional systems. At the reception, signals are detected by symmetric dipole or loop antenna and amplified by similar connected to the symmetric dipole or loop antenna.

The invention applies to both the transmission of RF energy as well as electrical energy in free space.

Due to various optical effects, such as Interference, diffraction, reflections could result non-uniform irregular signal strength and multiple signals present at the receiver. As the proposed system does not involve a ground radiator, the loses due to distributed ground radiator effects in existing system can be eliminated, resulting better directivity and less attenuation. This yields longer distance of transmission relative to present systems from the same available power.

In a performance test, signal strengths induced in a simple dipole placed at far field by newly developed ground-less complimentary transmitter FIG. 10 and the conventional type transmitter were measured FIG. 2 for same output power. The voltage induced at a half-wave dipole was directly measured by a isolated channel battery operated oscilloscope. Measured voltage values are shown in the Table 1. The frequency used for the measurement is 100 MHz.

The following Table depicts the performance comparison between newly developed ground-less complimentary transmitter FIG. 14 and conventional ground reference transmitter FIG. 2. The test frequency used for the measurement is 100 MHz.

TABLE 1

| | Measured output | Induced voltage @ |
|---|---|---|
| | voltage (rms) into 50Ω | 6 meters |
| New Tx sys | 2.5 V | 126 mV |
| Conventional Tx | 2.5 V | 84 mV |

According to the Table 1, the new Transmitter (Tx) induced 126 mV at a distance 6 meters while the convention system induced 84 mV at the same dipole. Accordingly, the following output performance was experimentally proved.

For a given output of the transmitting device in the conventional transmitter and the transmitter of the invention, the measured voltage induced at the receiving end of the new invention is higher than the induced voltage at the receiving end of the conventional system.

With the increase of directed power in space effectively with the new invention, the novel transmitter system, can transport energy (power in classical terms) very efficiently in space from one point to other. It is demonstrated that a power of fraction of watt can light up several incandescent lamps at several meters away.

FIG. 13 shows the practical arrangement of transmission of electrical energy wirelessly to a distant point.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of generating and transmitting and receiving electromagnetic power/energy comprising:
at signal generator stage, generating a signal using a ground-less complimentary oscillator which uses complementary configuration using complementary semiconductor pair/devices so that the signal is generated between two active terminals reference to each other;
wherein the oscillator operates without a common/fixed/ground potential;
amplifying signal using at least one ground-less dual-feed complementary amplifier stage which uses complementary configuration using complementary semiconductor pair/devices so that the signal amplifies through two active paths with reference to each other;
wherein the amplifier operates without common/fixed/ground potential;
transmitting the amplified signals through a medium to a receiving stage;
and at the receiving stage, amplifying the received signal through a cascade of ground-less dual-feed complementary amplifier stages where the complimentary amplifying stage amplifiers of the receiving stage operate without common/fixed/ground potential so that the signals are independently flowing in two active paths relative to each other.

2. The method according to claim 1 wherein the amplified signals are transmitted through space using a symmetrical antenna.

3. The method according to claim 1 wherein there is direct connection between transmitter output stage and symmetric radiator (dipole or loop antenna) without any matching network.

4. The method according to claim 1 wherein the signal is coupled between oscillator/amplifier and amplifier/amplifier using symmetrically fed balance-to-balance transformer.

5. The method according to claim 1 wherein the signal is coupled to the ground-less dual-feed complementary amplifier or between the ground-less dual-feed complementary amplifier by two conducting wires wound certain number of turns on a ferrite core in bifilar configuration.

6. The method according to claim 1 wherein for the complementary configuration, the method uses complementary electronic components.

7. The method according to claim 1 wherein the signal shares two active signal paths in complementary configuration.
